(19) United States
(12) Patent Application Publication
(10) Pub. No.: US 2013/0025417 A1
(43) Pub. Date: Jan. 31, 2013

(54) OPERATING TOOL ABLE TO BE ROTATED FOR ANGLES

(71) Applicant: Chen-Chang TSAI, Linnei Township (TW)

(72) Inventor: Chen-Chang TSAI, Linnei Township (TW)

(21) Appl. No.: 13/192,562

(22) Filed: Jul. 28, 2011

(51) Int. Cl. B25B 23/16

(52) U.S. Cl. 81/177.8

(57) ABSTRACT

An operating tool able to be rotated for angles includes a handle, a driving head and a quick-disengaging unit. The quick-disengaging unit is provided with a fixing member pivotally assembled with the handle, and the fixing member has one end secured with the driving head and another end provided with a position-limiting member to have the handle restrictedly positioned with the fixing member. The quick-disengaging unit also has an operating member, which is to slide in the fixing member, and a restraining element connected with the operating member and stuck between the fixing member and the handle. The operating member can be operated to move the restraining element off the handle so that the driving head, with the fixing member acting as a pivot, can be rotated relative to the handle for quickly screwing or unscrewing a thread locking member.

### BACKGROUND OF THE INVENTION

1. Field of the Invention

This invention relates to an operating tool able to be rotated for angles.

2. Description of the Prior Art

As commonly known, a wrench is employed for screwing or unscrewing a thread locking member (not shown) such as a bolt, and quick-rotating ratchet wrenches have been developed for the convenience of operation. A conventional quick-rotating ratchet wrench, as shown in FIGS. 1, 2 and 3, includes a handle 10, a driving head 20 and a quick-disengaging unit 30 combined together. The handle 10 has one end provided with a bulging block 11 disposed with an insert hole 12 and having a circumferential side bored with a through hole 13 communicating with the insert hole 12 and provided with first ratchet teeth 14. The driving head 20 is provided with a recessed groove 21 corresponding with the bulging block 11 and formed inside with an inner wall 21, which is provided with an annular recess 22 and second ratchet teeth 23. The quick-disengaging unit 30 has an operating member 31 provided to slide in the insert hole 12 and having both a shallow recess 311 and a deep recess 312 axially cut in a circumferential side. A first spring 32 is fitted around the operating member 31 of the quick-disengaging unit 30, which is further provided with a restraining unit 33 received in the through hole 13 of the bulging block 11 and composed of two steel balls 331, 332 and a second spring 333 positioned between the two steel balls 331 and 332. In a normal condition, the two steel balls 331, 332 of the restraining member 33 will respectively and elastically push against both the shallow recess 311 of the operating member 31 and the annular recess 22 of the driving head 20 to avoid the bulging block 11 of the handle 10 disengaging from the recessed groove 21 of the driving head 20 and hence, the handle 10 and the driving head 20 are impossible to rotate mutually because the first ratchet teeth 14 and the second ratchet teeth 23 tightly contact each other. To enable the driving head 20 to rotate quickly relative to the handle 10, referring to FIG. 3, only press down the operating member 31 to let the steel ball 331, which originally pushes against the shallow recess 311, changed to push against the deep recess 312, thus able to reduce the force that another steel ball 332 pushing against the annular recess 22. At this time, the handle 110 can easily be pulled upward and outward to disengage the first ratchet teeth 14 from the second ratchet teeth 23 and thus, the handle 10 can be operated to actuate the driving head 20 to rotate for 360 degrees for quickly screwing or unscrewing a thread locking member.

However, in the course of operating the driving head 20 to rotate quickly, restricted positioning between the bulging block 11 of the handle 10 and the recessed groove 21 of the driving head 20 is only effected by means of the steel ball 332 that pushes against the inner wall 211 of the recessed groove 21. Therefore, in an operating process, the bulging block 11 of the handle 10 is likely to cause disengagement in the recessed groove 21 of the driving head 20, resulting in a misgiving in safety of employing the conventional quickly-rotating ratchet wrench. In addition, the conventional quickly-rotating ratchet wrench using two steel balls for carrying out quick disengagement will add difficulty in production and assembly and increase cost, and the steel balls 331, 332 are liable to become deadlocked and especially, the second spring 333 may cause elastic fatigue after used for a long period.

### SUMMARY OF THE INVENTION

The objective of this invention is to offer an operating tool able to be rotated for angles, having a function of eliminating the defects of the conventional quick-rotating ratchet wrench that is unsafe in use, difficult in production and assembly and impossible to be used for long.

The operating tool able to be rotated for angles in the present invention includes a handle, a driving head and a quick-disengaging unit. The handle has one end provided with a first positioning portion with an insert hole having an interior formed with an inner wall, which is transversely disposed with a restraining portion. The driving head has one end provided with a second positioning portion to be correspondingly mounted with the first positioning portion of the handle. The quick-disengaging unit to be assembled between the first and the second positioning portion consists of a fixing member, an operating member, an elastic member and a restraining element. The fixing member has one end defined to be a fixing end to be inserted through the insert hole of the first positioning portion of the handle and transversely extended to form a positioning member. Further, the fixing member is formed with an accommodating space toward the fixing end at a location of the position-limiting member and has a circumferential side bored with a position-limiting hole communicating with the accommodating space. The operating member provided to slide in the accommodating space has a circumferential side axially and continuously cut with a shallow recess and a deep recess. The elastic member is positioned between the fixing member and the operating member, while the restraining element is positioned in the position-limiting hole of the fixing member and has two ends protruding out of the position-limiting hole and respectively pushing against the shallow recess of the operating member and the restraining portion of the handle.

In using the operating tool of this invention, when the operating member is pressed to shift downward, the restraining element will be shifted from the shallow recess to the deep recess of the operating member to avoid the restraining element being stuck to the restraining member of the handle and enable a user to lift up the handle for separating the first positioning portion from the second positioning portion. Thus, the user can directly operate the handle to actuate the driving head to rotate for 360 degrees for quickly screwing or unscrewing a thread locking member. In addition, the fixing end of the fixing member is secured with the second positioning portion of the driving head, while the free end of the fixing member is provided with the position-limiting member, and hence the handle can be restrictedly positioned on the fixing member.

Therefore, when the driving head is operated to rotate quickly, the handle will be impossible to separate from the driving head, thus insuring safety in using the operating tool of this invention. Furthermore, the operating tool able to be rotated at angles in the present invention is restrictedly positioned only by the restraining element that is stuck to both the shallow recess of the operating member and the restraining portion of the handle, simple in structure, easy in production and assembly, low in cost and able to eliminate the defects of the conventional quick-rotating ratchet wrench that employs two steel balls and a spring to make up a quick-disengaging unit, nevertheless, the steel balls likely to become deadlocked and the spring easy to produce elastic fatigue.

### BRIEF DESCRIPTION OF DRAWINGS

This invention will be better understood by referring to the accompanying drawings, wherein:

FIG. 1 is an exploded perspective view of a conventional wrench;

FIG. 2 is a cross-sectional view of the conventional wrench;

FIG. 3 is a cross-sectional view of the conventional wrench in a using condition;

FIG. 4 is a perspective view of an operating tool able to be rotated for angles in the present invention;

FIG. 5 is an exploded perspective view of the operating tool able to be rotated for angles in the present invention;

FIG. 6 is a cross-sectional view of the operating tool able to be rotated for angles in the present invention;

FIG. 7 is a cross-sectional view of the operating tool bale to be rotated for angles in a using condition in the present invention, illustrating that an operating member is pressed down;

FIG. 8 is a cross-sectional view of the operating tool able to be rotated for angles in a using condition in the present invention, illustrating that the operating member is released; and

FIG. 9 is a schematic view of the operating tool able to be rotated for angles in a using condition in the present invention, illustrating that the handle of the operating tool is operated to actuate the driving head to rotate quickly.

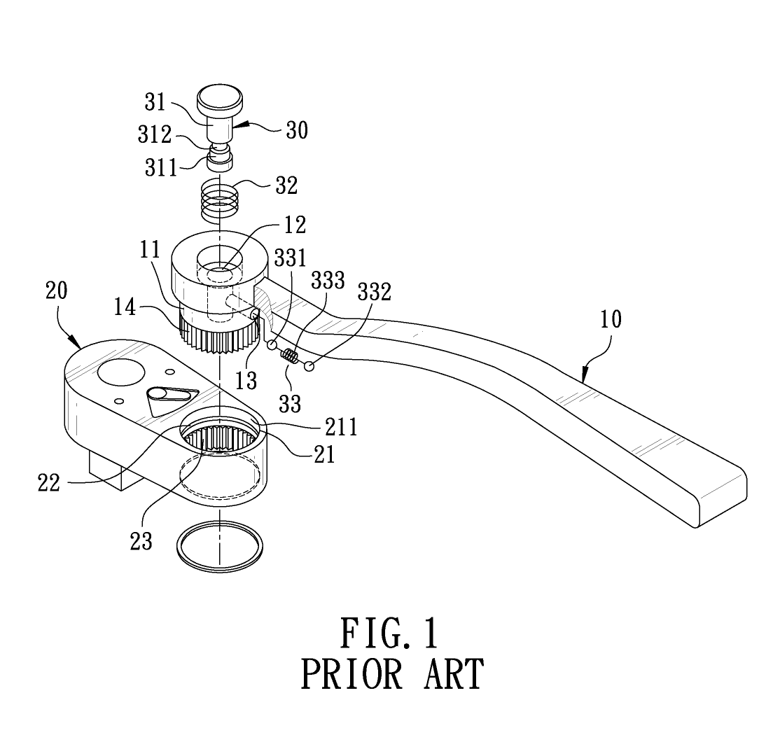

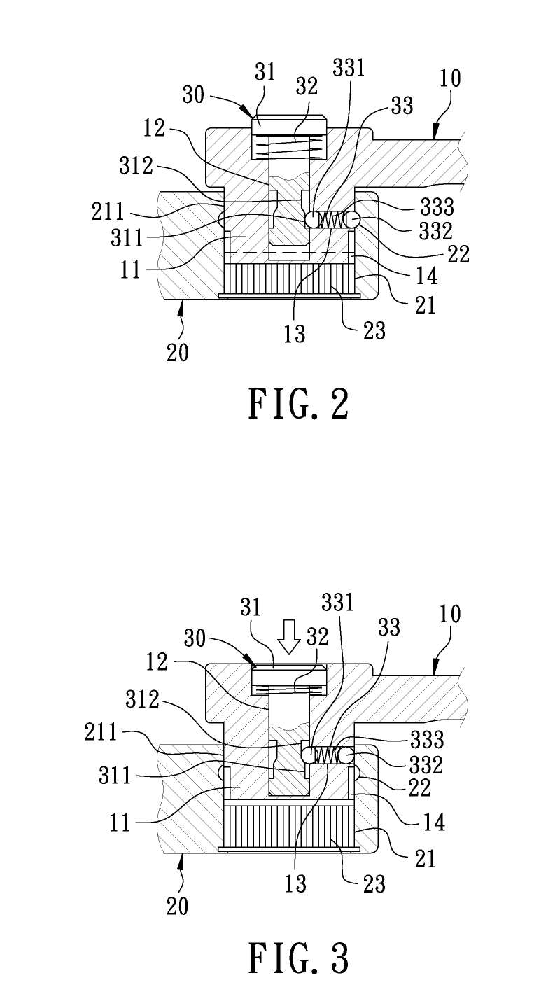

### DETAILED DESCRIPTION OF THE PREFERRED EMBODIMENT

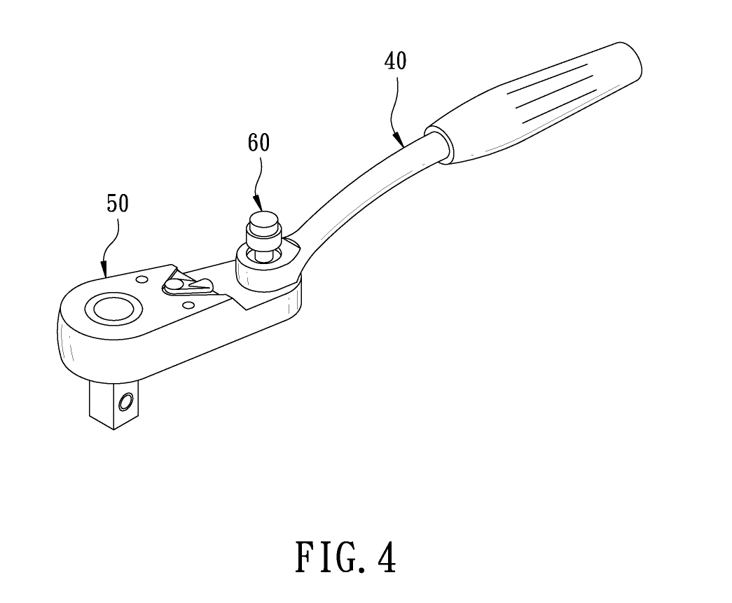

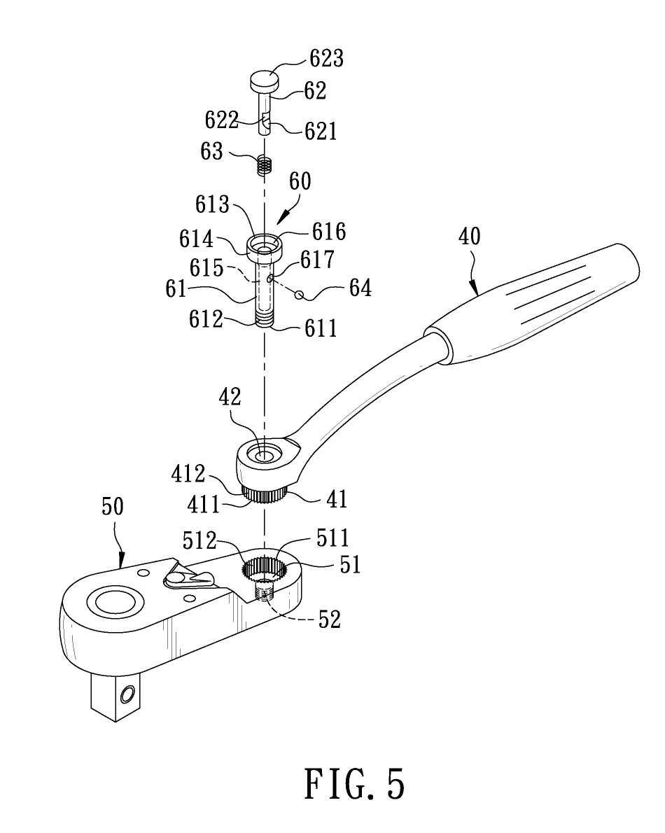

A preferred embodiment of an operating tool able to be rotated for angles in the present invention, as shown in FIGS. 4, 5 and 6, includes a handle 40, a driving head 50 and a quick-disengaging unit 60 as main components combined together.

The handle 40 has one end provided with a first positioning portion 41 that is a circular bulging block 411 having an annular side provided with first ratchet teeth 412. Further, the first positioning portion 41 is bored with an insert hole 42 having an inner wall 421 transversely fixed thereon with a restraining member 43, which is composed of a first annular recess 431 and a second annular recess 432.

The driving head 50 has one end formed with a second positioning portion 51 to be correspondingly fitted with the first positioning portion 41 of the handle 40. In this preferred embodiment, the second positioning portion 51 is a circular recessed groove 511. The driving head 50 is further bored with a locking hole 52 in the second positioning portion 51.

The quick-disengaging unit 60 is to be assembled between the first and the second positioning portion 41 and 51, consisting of a fixing member 61, an operating member 62, an elastic member 63 and a restraining element 64.

The fixing member 61 has one end defined to be a fixing end 611 that is to be inserted through the insert hole 42 and secured with the second positioning portion 51 of the driving head 50. In this preferred embodiment, the fixing member 61 has the fixing end 611 provided with a section of threads 612 to be screwed with the locking hole 52 of the driving head 50 and secured with the second positioning portion 51. Another end of the fixing member 61 is a free end 613 transversely extended to form a position-limiting member 614 that is disposed with an accommodating space 615 toward the fixing end 611 and an accommodating groove 616, which is larger in diameter than the accommodating space 615. Additionally, the fixing member 61 has a circumferential side bored with a position-limiting hole 617 communicating with the accommodating space 615.

The operating member 62 is provided to slide in the accommodating space 615 of the fixing member 61, having a circumferential side axially and continuously cut with a shallow recess 621 and a deep recess 622 and a head 623 for corresponding with the accommodating groove 616 of the fixing member 61.

The elastic member 63 is a spring positioned between the fixing member 61 and the operating member 62, fitted around the operating member 62 and having two ends respectively positioned with the accommodating groove 616 of the fixing member 61 and the head 623 of the operating member 62.

The restraining element 64 is a steel ball to be received in the position-limiting hole 617 of the fixing member 61, having two opposite ends protruding out of the position-limiting hole 617 and respectively pushing against the shallow recess 621 of the operating member 62 and the first annular recess 431 of the restraining member 43 of the handle 40.

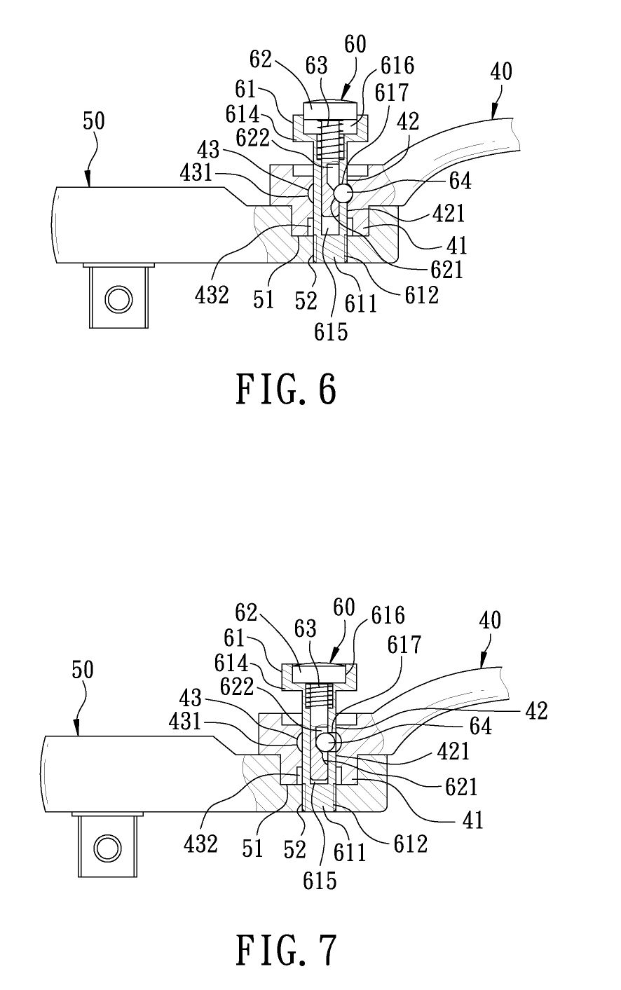

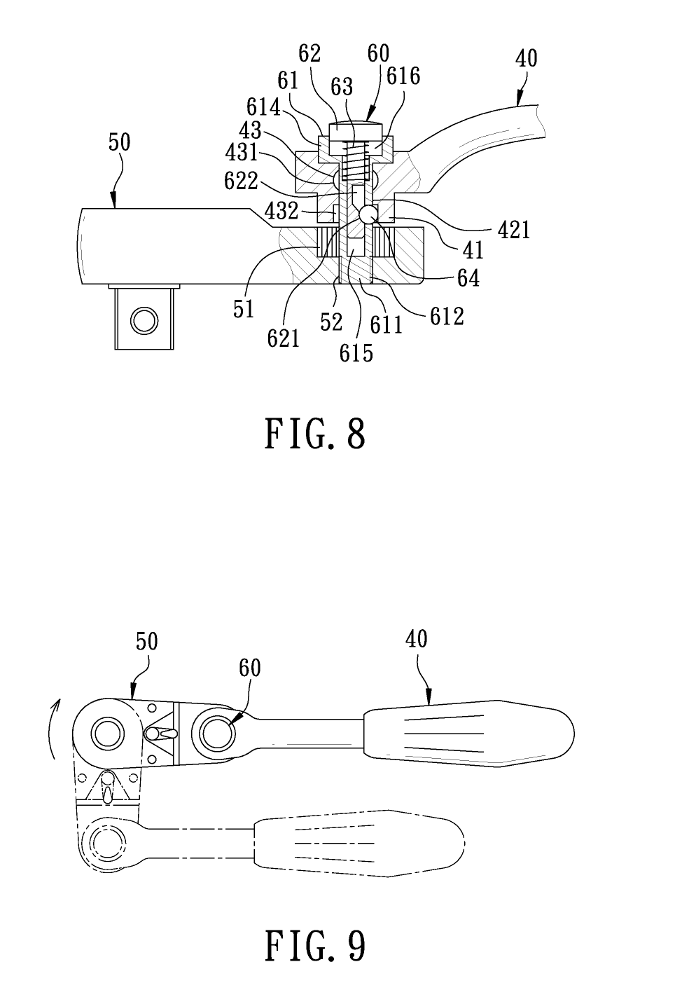

Referring to FIGS. 6, 7 and 8, in a normal condition, the first positioning portion 41 of the handle 40 is firmly positioned with the second positioning portion 51 of the driving head 50, and the restraining element 64 is restrictedly positioned on the shallow recess 621 of the operating member 62 and on the first annular recess 431 of the restraining member 43, as shown in FIG. 6; therefore, the first positioning portion 41 is impossible to disengage from the second positioning portion 51, and the first ratchet teeth 412 and the second ratchet teeth 512 are meshed with each other to enable a user to directly operate the operating tool for screwing or unscrewing a thread locking member (not shown). On the other hand, to enable the driving head 50 to rotate quickly relative to the handle 40, referring to FIG. 7, only press the operating member 62 to shift downward to let the restraining element 64 shifted from the shallow recess 621 to the deep recess 622 so that the restraining element 64 may no longer stick with the first annular recess 431 of the restraining member 43 of the handle 40. Thus, the handle 40 can be lifted up to disengage the first positioning portion 41 from the second positioning portion 51 and let the first ratchet teeth 412 and the second ratchet teeth 512 disengaged from each other. At this time, the driving head 50, with operating member 62 acting as a pivot, can be rotated relative to the handle 40, and so long as the operating member 62 is released, the operating member 62 will be pushed by the restoring elastic force of the elastic member 63 to slide upward and actuate the restraining element 64 to be stuck to the shallow recess 621 and to the second annular recess 432 of the restraining member 43 to have the handle 40 restrictedly positioned between the position-limiting member 614 of the fixing member 61 and the restraining element 64. By so designing, a user can directly operate the handle 40 to actuate the driving head 50 to rotate for 360 degrees to screw or unscrew a thread locking member with quickness, as shown in FIG. 9. Moreover, since the fixing end of the fixing member 61 is secured with the second positioning portion 51 of the driving head 50, and the free end 613 of the fixing member 61 is provided with the position-limiting member 614; therefore, the handle 40 can be restrictedly positioned firmly on the fixing member 61. Thus, when a user operates the driving head 50 to rotate quickly, the handle 40 and the driving head 50 will not be separated from each other so the operating tool of this invention can be used with great safety.

Obviously, the operating tool able to be rotated for angles in the present invention carries out restricted positioning only by means of the restraining element 64 that is stuck to both the shallow recess 621 of the operating member 62 and the restraining portion of the handle 40, simple in structure, easy in production and assembly, low in cost and able to completely eliminate the shortcomings of the conventional quick-rotating ratchet wrench that uses two steel balls and a spring to be a quick-disengaging unit, but the steel balls are likely to become deadlocked and the spring is easy to cause elastic fatigue.

While the preferred embodiment of the invention has been described above, it will be recognized and understood that various modifications may be made therein and the appended claims are intended to cover all such modifications that may fall within the spirit and scope of the invention.

What is claimed is:

1. An operating tool able to be rotated for angles comprising:
a handle having one end provided with a first positioning portion, said first positioning portion bored with an insert hole, said insert hole formed with an inner wall in an interior, said inner wall transversely formed with a restraining member;
a driving head having one end disposed with a second positioning portion corresponding with said first positioning portion, said second positioning portion able to be positioned with said first positioning portion; and
a quick-disengaging unit assembled between said first positioning portion and said second positioning portion, said quick-disengaging unit composed of a fixing member, an operating member, an elastic member and a restraining element:
said fixing member having one end defined to be a fixing end to be inserted through said insert hole and secured with said second positioning portion, another end of said fixing member being a free end transversely extended to form a position-limiting member, said position-limiting member disposed with an accommodating space toward said fixing end of said fixing member, said fixing member having a circumferential side bored with a position-limiting hole;
said operating member provided to slide in said accommodating space, said operating member having a circumferential side axially and continuously cut with a shallow recess and a deep recess;
said elastic member assembled between said fixing member and said operating member; and
said restraining element received in said position-limiting hole, said restraining element having two ends protruding out of said position-limiting hole and respectively pushing against said shallow recess and said restraining member.

2. An operating tool able to be rotated for angles as claimed in claim 1, wherein said first positioning portion is a circular bulging block having an annular side provided with first ratchet teeth, while said second positioning portion is a circular recessed groove having an inner wall disposed with second ratchet teeth around itself.

3. An operating tool able to be rotated for angles as claimed in claim 1, wherein said restraining member is composed of a first annular recessed groove and a second annular recessed groove around said inner wall.

4. An operating tool able to be rotated for angles as claimed in claim 1, wherein said second positioning portion is bored with a locking hole, while said fixing end of said fixing member is provided with a section of threads to be screwed with said locking hole.

5. An operating tool able to be rotated for angles as claimed in claim 1, wherein said position-limiting member of said fixing member is formed with an accommodating groove that is larger in diameter than said accommodating space, said elastic member fitted around said operating member and having two ends respectively positioned with said accommodating groove and said head.
